(19) United States
(12) Patent Application Publication
(10) Pub. No.: US 2016/0096230 A1
(43) Pub. Date: Apr. 7, 2016

(54) Generative Gear Machining Method and Apparatus

(71) Applicant: DMG MORI SEIKI ADVANCED SOLUTIONS, INC., Hoffman Estates, IL (US)

(72) Inventors: Gregory A. Hyatt, South Barrington, IL (US); Nitin Chaphalkar, Schaumburg, IL (US)

(73) Assignee: DMG MORI SEIKI ADVANCED SOLUTIONS, INC., Hoffman Estates, IL (US)

(21) Appl. No.: 14/889,582

(22) PCT Filed: May 5, 2014
(86) PCT No.: PCT/US14/36805

§ 371 Date: Nov. 6, 2015

Related U.S. Application Data
(60) Provisional application No. 61/819,874, filed on May 6, 2013.

(51) Int. Cl. B23F 17/00; B23F 19/00; B23F 5/22

(52) U.S. Cl. CPC B23F 17/006; B23F 5/22; B23F 19/002

(57) ABSTRACT

Gear machining apparatus and methods are configured to produce gaps between gear teeth having portions formed by two different machining processes. A rough cutting process may be used to form a root portion of the gap, while a finish cutting process may be used to form final tooth faces. The apparatus and methods may further be configured to machine one or more gear tooth profile modifications.

### BACKGROUND

1. Technical Field

The present disclosure generally relates to computed numerically controlled machine tools, and more particularly, to methods and apparatus for machining gears having gear teeth using computer controlled machine tools.

2. Description of the Related Art

Computed Numerically Controlled (CNC) machine tools are generally known for machining metal and wooden parts. Such machine tools include lathes, milling machines, grinding machines, and other tool types. More recently, machining centers have been developed, which provide a single machine having multiple tool types and capable of performing multiple different machining processes. Machining centers may generally include one or more tool retainers, such as spindle retainers and turret retainers holding one or more tools, and a workpiece retainer, such as a pair of chucks. The workpiece retainer may be stationary or move (in translation and/or rotation) while a tool is brought into contact with the workpiece, thereby removing material from the workpiece.

Machine tools, whether numerically controlled, computer numerically controlled, manually operated, or otherwise, have been used to machine gears. Known gear machining apparatus and methods typically use a single cutting operation to generate the gaps between adjacent teeth of the gear. In hobbing operations, for example, a hob tool is rotated and brought into contact with one or more blanks, which are also rotated. The hob tool includes cutting teeth that are arranged in a helical pattern around the cylindrical hob body. The hob teeth have cross-sectional profiles that generate the profiles of the gaps to be machined between adjacent gear teeth. Consequently, a given hob tool is capable of producing only one type of gear tooth profile. Accordingly, while hobbing is generally believed to be a quick and efficient method of machining gears, a user must keep a variety of different hob tools on hand in order to create gears having different tooth profiles.

More recently, a gear machining process has been proposed that exclusively uses a controlled tool path to machine the gear tooth profiles. German Patent Application No. DE 10 2010 042 835 A1 to Scherbarth discloses a method of milling gear teeth using a milling cutter. The milling cutter includes a plurality of cutter inserts having a straight profile cutting edge. During operation, the milling cutter is rotated and controlled along a tool path that removes material between adjacent gear teeth to form each gear tooth profile. In one embodiment, a first tool path causes the milling cutter to machine a root of the tooth gap, a second tool path is used to machine the flank and face of one side of a gear tooth, and a third tool path is used to machine the flank and face of one side of an adjacent gear tooth. In other embodiments, a complex tool path is used to machine, sequentially, the face and flank of one side of a gear tooth, the root of the tooth gap, and the flank and face of one side of an adjacent gear tooth. In each of the embodiments disclosed in Scherbarth, therefore, the milling cutter is used to machine the entire tooth profile. While the use of a tool path driven process expands the variety of gear tooth profiles that may be machined by a single tool, the milling process of Scherbarth typically requires more time to machine a complete gear.

### SUMMARY OF THE DISCLOSURE

In accordance with one aspect of the present disclosure, a method is provided of machining a gear from a workpiece, wherein the gear has a series of gear teeth separated by intervening gaps. The method includes securing the workpiece in a workpiece retainer, the workpiece having a work surface, and providing a rough cutting tool in a rough tool retainer, the rough cutting tool including a series of cutting teeth. One or more of the workpiece retainer and the rough tool retainer is controlled such that the cutting teeth engage the work surface to machine a series of initial gaps in the workpiece, each initial gap having an initial gap profile defined by the cutting teeth and including a gap root portion and an adjacent pair of initial tooth faces. The method further includes providing a finish cutting tool having a finish cutting surface in a finish tool retainer. One or more of the workpiece retainer and the finish tool retainer is controlled such that the finish cutting surface machines each initial tooth face into a final tooth face, so that each intervening gap comprises a gap root portion disposed between an adjacent pair of final tooth faces.

In accordance with another aspect of the present disclosure that may be combined with any one of the other aspects disclosed herein, an apparatus is provided for machining a gear from a workpiece, the gear having a series of gear teeth separated by intervening gaps. The apparatus includes a workpiece retainer configured to movably support the workpiece, the workpiece having a work surface, a rough tool retainer configured to be movable relative to the workpiece retainer, and a rough cutting tool coupled to the rough tool retainer, the rough cutting tool including a series of cutting teeth. A finish tool retainer is configured to be movable relative to the workpiece retainer, and a finish cutting tool coupled to the finish tool retainer. A computer control system includes a computer readable medium having computer executable code disposed thereon and is in operative communication with each of the workpiece retainer, the rough tool retainer, and the finish tool retainer. The executable code configures the control system to control one or more of the workpiece retainer and the rough tool retainer such that the cutting teeth engage the work surface to machine a series of initial gaps in the workpiece, each initial gap having an initial gap profile defined by the cutting teeth and including a gap root portion and an adjacent pair of initial tooth faces, and control one or more of the workpiece retainer and the finish tool retainer such that the finish cutting surface machines each initial tooth face into a final tooth face, so that each intervening gap comprises a gap root portion disposed between an adjacent pair of final tooth faces.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a front elevation of a computer numerically controlled machine in accordance with one embodiment of the present invention, shown with safety doors closed;

FIG. 2 is a front elevation of a computer numerically controlled machine illustrated in FIG. 1, shown with the safety doors open;

FIG. 3 is a perspective view of certain interior components of the computer numerically controlled machine illustrated in FIGS. 1 and 2, depicting a machining spindle, a first chuck, a second chuck, and a turret;

FIG. 4 a perspective view, enlarged with respect to FIG. 3 illustrating the machining spindle and the horizontally and vertically disposed rails via which the spindle may be translated;

FIG. 5 is a side view of the first chuck, machining spindle, and turret of the machining center illustrated in FIG. 1;

FIG. 6 is a view similar to FIG. 5 but in which a machining spindle has been translated in the Y-axis;

FIG. 7 is a front view of the spindle, first chuck, and second chuck of the computer numerically controlled machine illustrated in FIG. 1, including a line depicting the permitted path of rotational movement of this spindle;

FIG. 8 is a perspective view of the second chuck illustrated in FIG. 3, enlarged with respect to FIG. 3;

FIG. 9 is a perspective view of the first chuck and turret illustrated in FIG. 2, depicting movement of the turret and turret stock in the Z-axis relative to the position of the turret in FIG. 2;

FIG. 10 is a perspective view of yet another computer numerically controlled machine in accordance with one embodiment of the present invention;

FIGS. 11A and 11B are diagrammatic views of a machining area of the machine of FIG. 10 carrying out a gear machining process according to a first embodiment disclosed herein;

FIG. 12 is an enlarged side view, in partial cross-section, of a hob tool;

FIG. 13 is an enlarged partial side view of a gear produced by the gear machining method and apparatus disclosed herein;

FIG. 14 is a diagrammatic view of a machining area of the machine of FIG. 10 carrying out a gear machining process according to an alternative embodiment disclosed herein;

FIG. 15 is a diagrammatic view of a machining area of the machine of FIG. 10 carrying out a gear shaping process according to an alternative embodiment disclosed herein;

FIG. 16 is a diagrammatic view of a gear tooth having a profile modified by a tip relief surface and a root relief surface;

FIG. 17 is a diagrammatic view of a gear tooth having a profile modified with crowning; and

FIG. 18 is a diagrammatic view of gear tooth embodiments having profiles modified with profile shifts.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

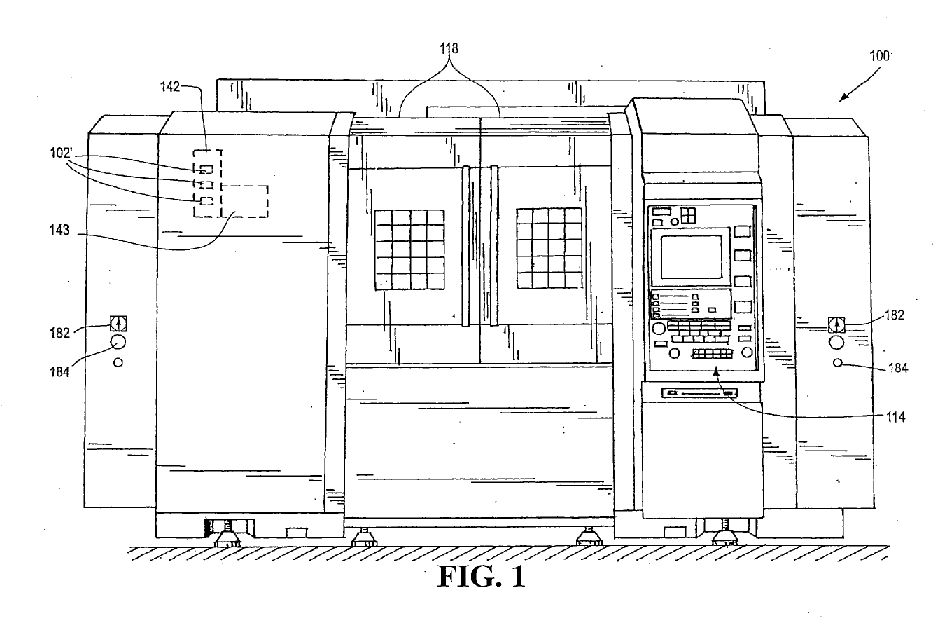

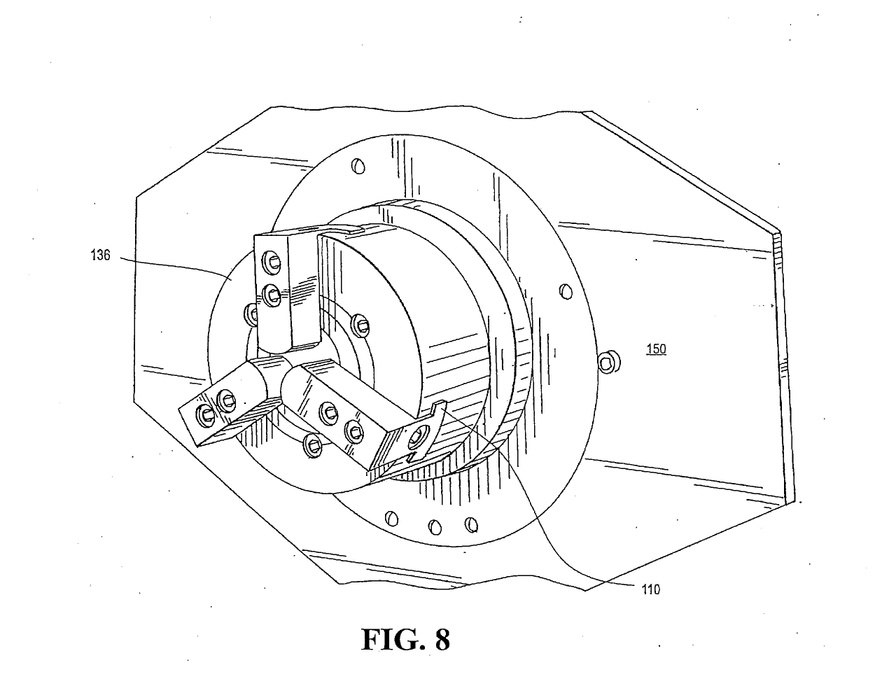

Any suitable apparatus may be employed in conjunction with the methods disclosed herein. In some embodiments, the methods are performed using a computer numerically controlled machine, illustrated generally in FIGS. 1-9. A computer numerically controlled machine is itself provided in other embodiments. The machine 100 illustrated in FIGS. 1-9 is an NT-series machine, versions of which are available from DMG/Mori Seiki USA, the assignee of the present application. Other machines, however, may be used to perform the methods disclosed herein.

In general, with reference to the NT-series machine illustrated in FIGS. 1-3, one suitable computer numerically controlled machine 100 has at least a first retainer and a second retainer, each of which may be a tool retainer (such as a spindle retainer associated with spindle 144 or a turret retainer associated with a turret 108) or a workpiece retainer (such as chucks 110, 112). In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

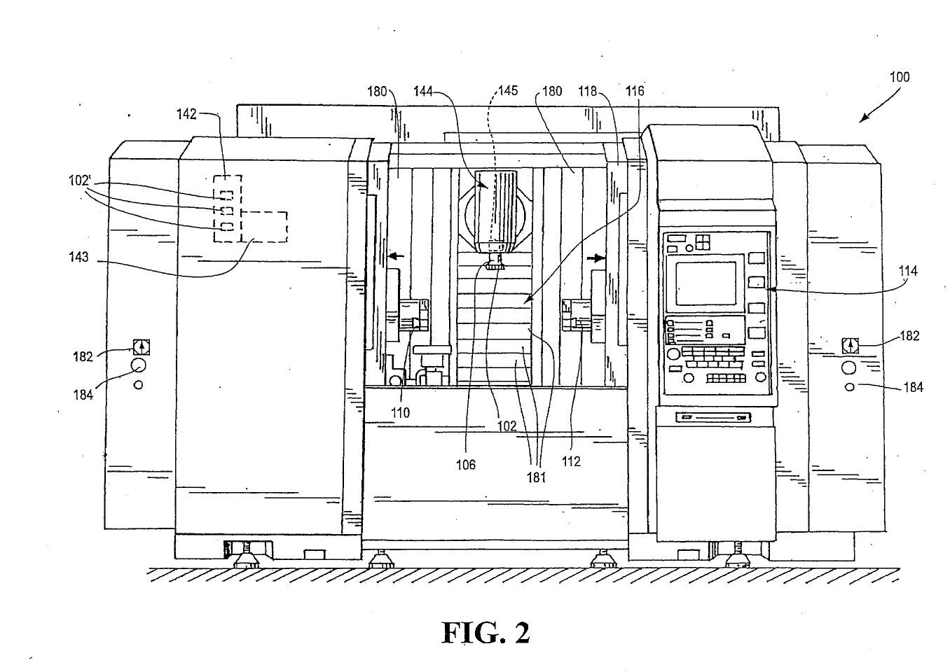

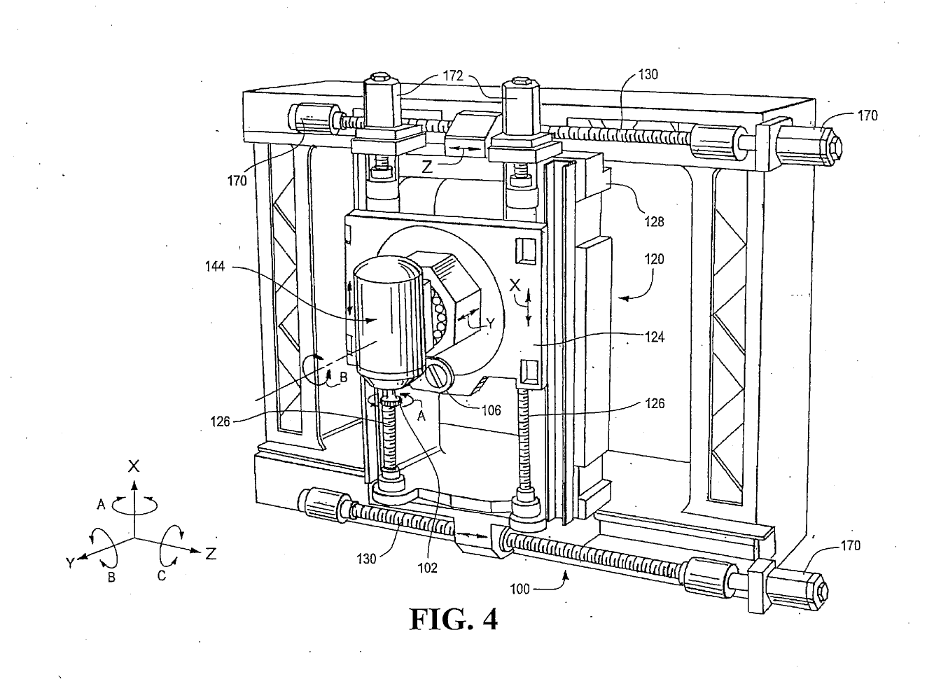

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the chamber 116 to prevent injury to the user or interference in the operation of the computer numerically controlled machine 100. The safety doors 118 can be opened to permit access to the chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface system 114 allows an operator to control the second computer system. Collectively, the machine control system and the user interface system, together with the various mechanisms for control of operations in the machine, may be considered a single computer control system. In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically controlled machine 100 may have a tool magazine 142 and a tool changing device 143. These cooperate with the spindle 144 to permit the spindle to operate with plural cutting tools (shown in FIG. 2 as tools 102′). Generally, a variety of cutting tools may be provided; in some embodiments, multiple tools of the same type may be provided.

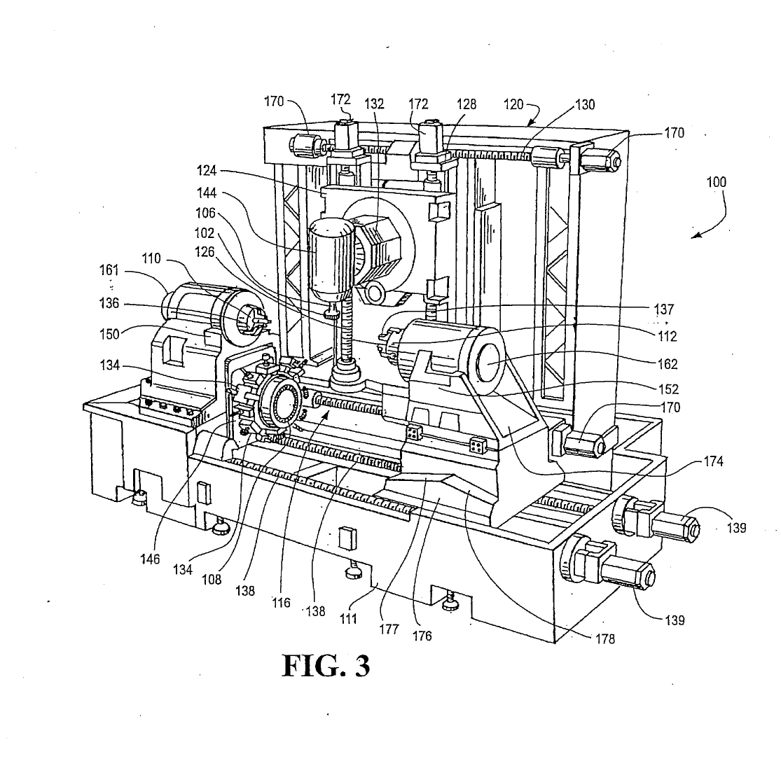

The spindle 144 is mounted on a carriage assembly 120 that allows for translational movement along the X- and Z-axis, and on a ram 132 that allows the spindle 144 to be moved in the Y-axis. The ram 132 is equipped with a motor to allow rotation of the spindle in the B-axis, as set forth in more detail below. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

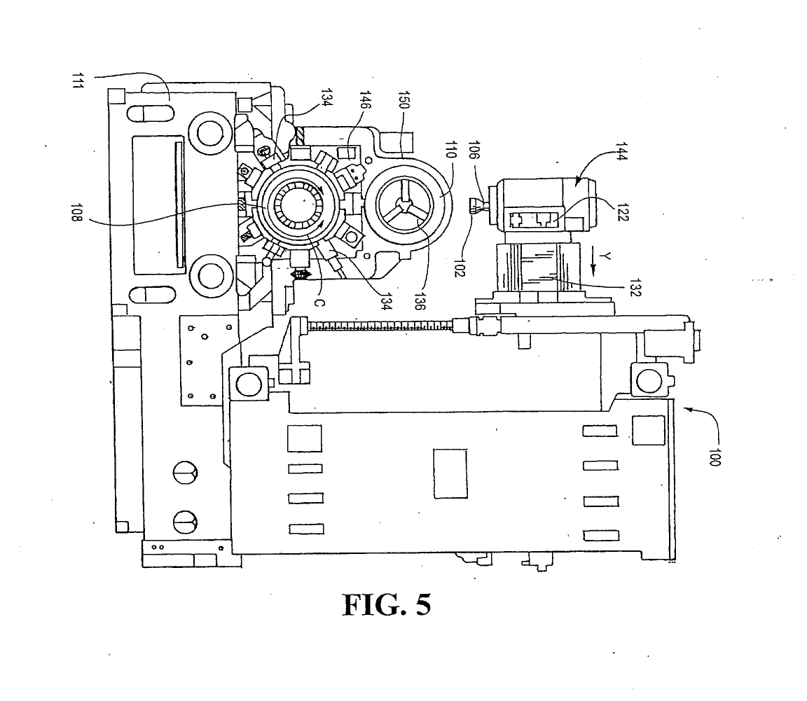

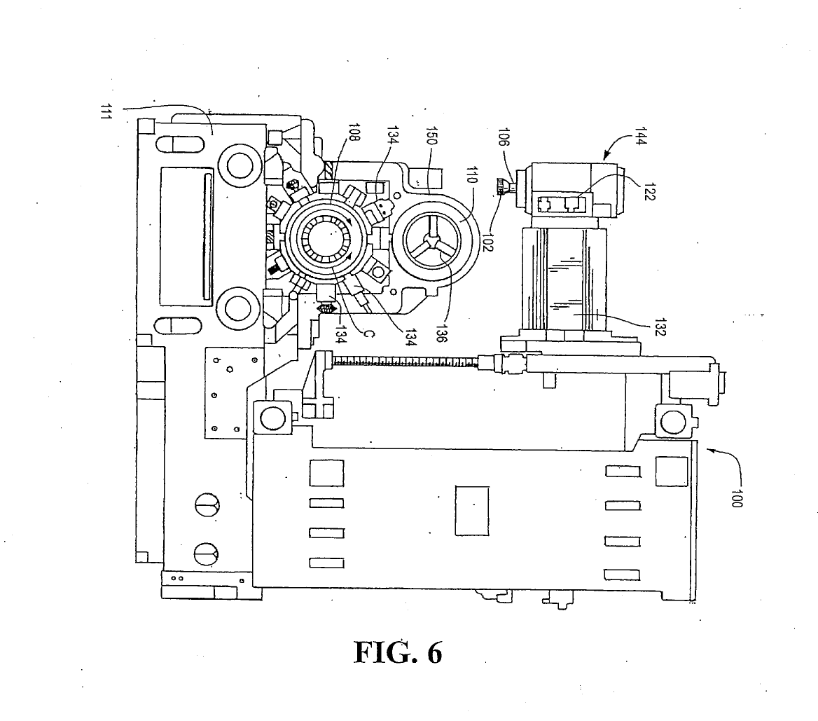

The spindle 144 holds the cutting tool 102 by way of a spindle connection and a tool retainer 106. The spindle connection 145 (shown in FIG. 2) is connected to the spindle 144 and is contained within the spindle 144. The tool retainer 106 is connected to the spindle connection and holds the cutting tool 102. Various types of spindle connections are known in the art and can be used with the computer numerically controlled machine 100. Typically, the spindle connection is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

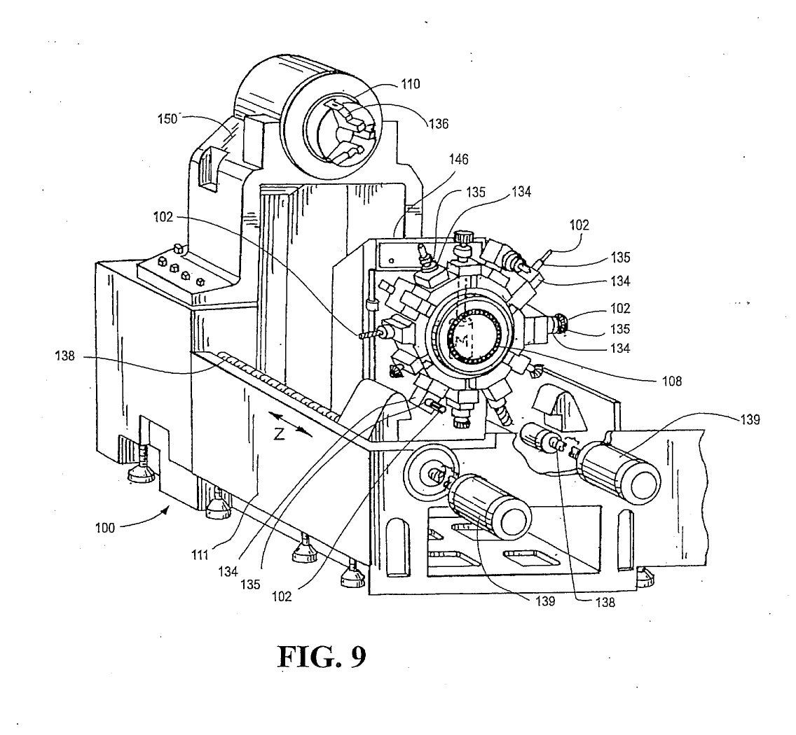

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool retainer 135 or other connection for connecting to a cutting tool. Since the turret 108 can have a variety of turret connectors 134 and tool retainers 135, a variety of different cutting tools can be held and operated by the turret 108. The turret 108 may be rotated in a C′ axis to present different ones of the tool retainers (and hence, in many embodiments, different tools) to a workpiece.

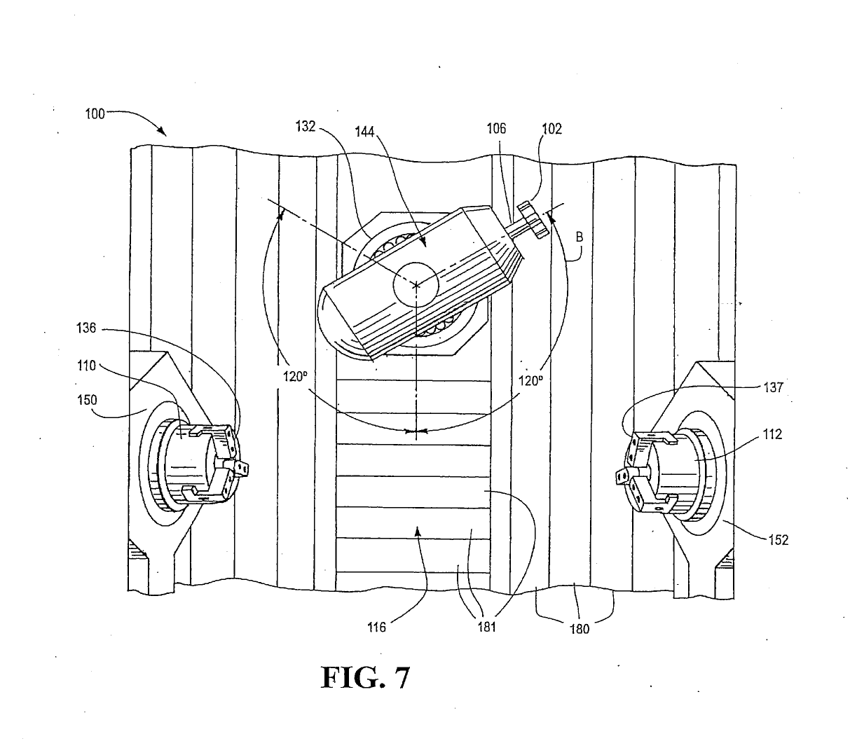

It is thus seen that a wide range of versatile operations may be performed. With reference to tool 102 held in tool retainer 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changing device 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120 degrees to either side of the vertical. Movement in the Y direction and rotation in the B axis are powered by motors (not shown) that are located behind the carriage 124.

Generally, as seen in FIGS. 2 and 7, the machine is provided with a plurality of vertically disposed leaves 180 and horizontal disposed leaves 181 to define a wall of the chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of cutting tools known in the art or otherwise found to be suitable. For instance, the cutting tool 102 may be a milling tool, a drilling tool, a grinding tool, a blade tool, a broaching tool, a turning tool, or any other type of cutting tool deemed appropriate in connection with a computer numerically controlled machine 100. As discussed above, the computer numerically controlled machine 100 may be provided with more than one type of cutting tool, and via the mechanisms of the tool changing device 143 and magazine 142, the spindle 144 may be caused to exchange one tool for another. Similarly, the turret 108 may be provided with one or more cutting tools 102, and the operator may switch between cutting tools 102 by causing rotation of the turret 108 to bring a new turret connector 134 into the appropriate position.

Other features of a computer numerically controlled machine include, for instance, an air blower for clearance and removal of chips, various cameras, tool calibrating devices, probes, probe receivers, and lighting features. The computer numerically controlled machine illustrated in FIGS. 1-9 is not the only machine of the invention, but to the contrary, other embodiments are envisioned.

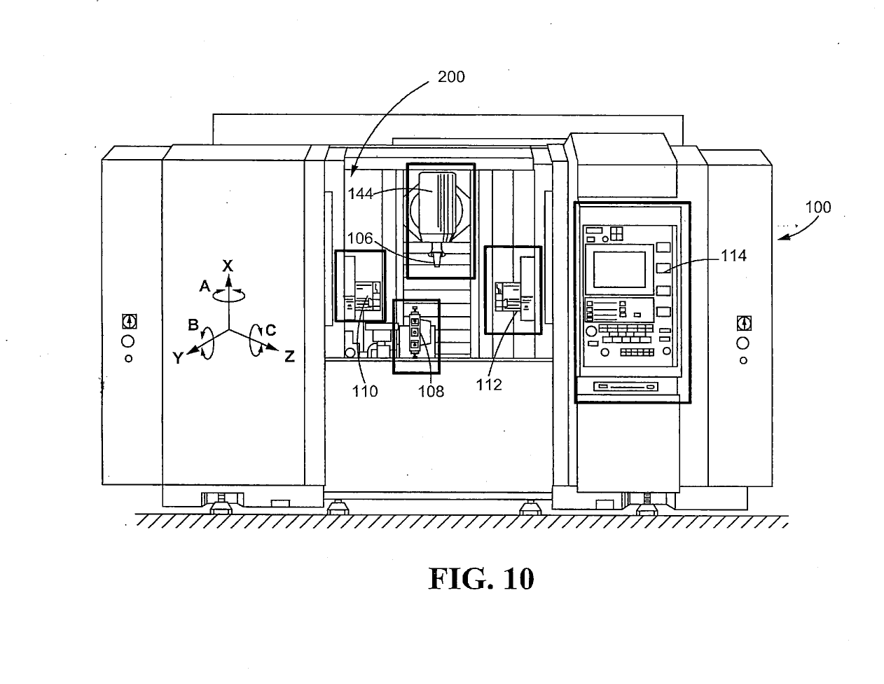

Among other things, the computer numerically controlled machine 100 may be configured and controlled to perform gear machining operations more efficiently and effectively than previously known machines. As shown in the exemplary embodiment of FIG. 10, for example, the computer numerically controlled machine 100 may be provided with at least a tool retainer 106 disposed on a spindle 144, a turret 108, one or more chucks or workpiece retainers 110, 112 as well as a user interface 114 configured to interface with a computer control system of the computer numerically controlled machine 100. Each of the tool retainer 106, spindle 144, turret 108 and workpiece retainers 110, 112 may be disposed within a machining area 200 and selectively rotatable and/or movable relative to one another along one or more of a variety of axes.

As indicated in FIG. 10, for example, the X, Y, and Z axes may indicate orthogonal directions of movement, while the A, B, and C axes may indicate rotational directions about the X, Y, and Z axes, respectively. These axes are provided to help describe movement in a three-dimensional space, and therefore, other coordinate schemes may be used without departing from the scope of the appended claims. Additionally, use of these axes to describe movement is intended to encompass actual, physical axes that are perpendicular to one another, as well as virtual axes that may not be physically perpendicular but in which the tool path is manipulated by a controller to behave as if they were physically perpendicular.

With reference to the axes shown in FIG. 10, the tool retainer 106 may be rotated about a B-axis of the spindle 144 upon which it is supported, while the spindle 144 itself may be movable along an X-axis, a Y-axis and a Z-axis. The turret 108 may be movable along an XA-axis substantially parallel to the X-axis and a ZA-axis substantially parallel to the Z axis. The workpiece retainers 110, 112 may be rotatable about a C-axis, and further, independently translatable along one or more axes relative to the machining area 200. It will be understood that the axes of movement noted above are merely exemplary, as they may be movable with respect to fewer or more than the axes identified above. Furthermore, the methods and apparatus disclosed herein may be used in conjunction with a computer numerically controlled machine that is minimally configured to enable four axes of movement when a dedicated cooling center is not provided, or a machine minimally that is configured to enable at least two axes of movement when a dedicated cooling center is provided.

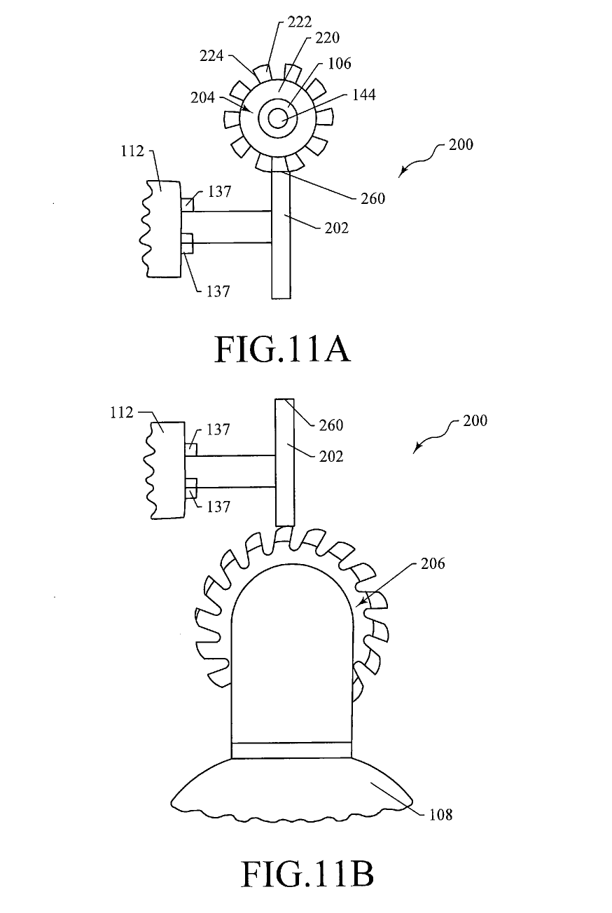

Turning to FIGS. 11A and 11B, an exemplary arrangement of the machining area 200 for machining a gear from a workpiece 202. As shown, the workpiece 202 may be movably supported by one of the workpiece retainers 112, and more particularly, secured between a plurality of jaws 137 thereof. As shown in FIG. 11A, a finish cutting tool such as a milling tool 204 may be similarly supported and secured by the tool retainer 106 of the spindle 144. As shown in FIG. 11B, a rough cutting tool, such as a hob tool 206, may be supported and secured by the turret 108. Moreover, one or more of the workpiece retainer 112, the tool retainer 106, and the turret 108 may be positioned such that cutting surfaces of the milling tool 204 and the hob tool 206 are readily capable of engaging even and adequate contact with the work surface of the workpiece 202 as shown.

While FIGS. 11A and 11B illustrate an exemplary tool arrangement, it will be appreciated that other tool arrangements may be used without departing from the scope of this disclosure. For example, the hob tool 206 may be supported and secured by the tool retainer 106 of the spindle 144, while the milling tool 204 may be supported and secured by the turret 108. Other tool configurations in addition to those disclosed herein may also be used.

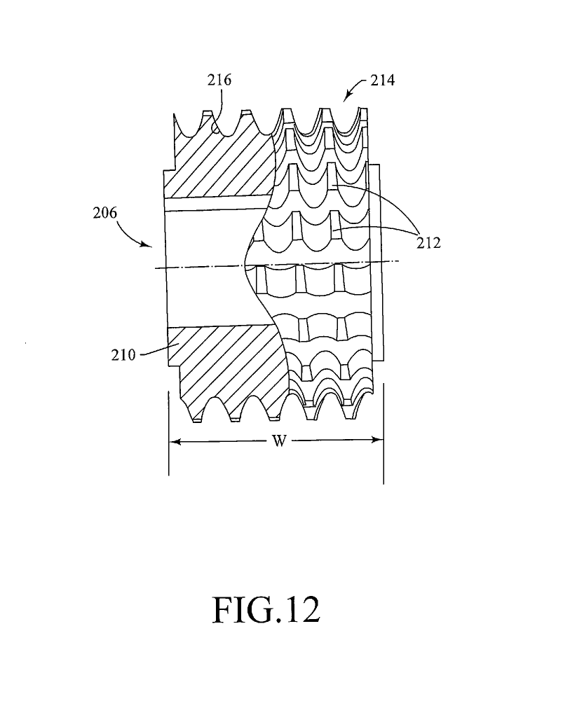

The hob tool 206 is shown in greater detail in FIG. 12. In the exemplary embodiment, the hob tool 206 may include a hub 210 from which project a plurality of hob cutting teeth 212. The hob cutting teeth 212 are arranged in a spiral or helical pattern around the hub 210 to define hob grooves 214 between adjacent rows of hob cutting teeth 212. The hob cutting teeth 212 may have individual profiles which together define the shape of the void machined when the hob cutting teeth 212 engage the workpiece 202. While the illustrated hob tool 206 includes multiple rows of cutting teeth 212, the hob tool 206 may alternatively have a reduced helix, including as few as a helix of cutting teeth 212, thereby reducing the overall width W of the hob tool 206.

The milling tool 204 may have a milling hub 220 defining a plurality of receptacles for releasably securing cutting tool inserts 222 (FIG. 11A). Each cutting tool insert 222 may have a cutting surface 224 for engaging and removing material from the workpiece 202. In the illustrated embodiment, the cutting surface 224 is substantially planar, and therefore the shape of the void created is dependent on a tool path along which the milling tool 204 travels.

Still referring to FIGS. 10, 11A, and 11B, the computer control system of the machine 100 may be operatively coupled to one or more of the tool retainer 106, the turret 108, the workpiece retainer 112, and the spindle 144, and further, may be preprogrammed with an algorithm or a set of instructions for executing a gear machining sequence or routine. In particular, the computer control system may include or at least communicate with a computer readable medium having computer executable code disposed thereon configured to instruct the computer control system and the machine 100 to function according to the algorithm or a series of method steps.

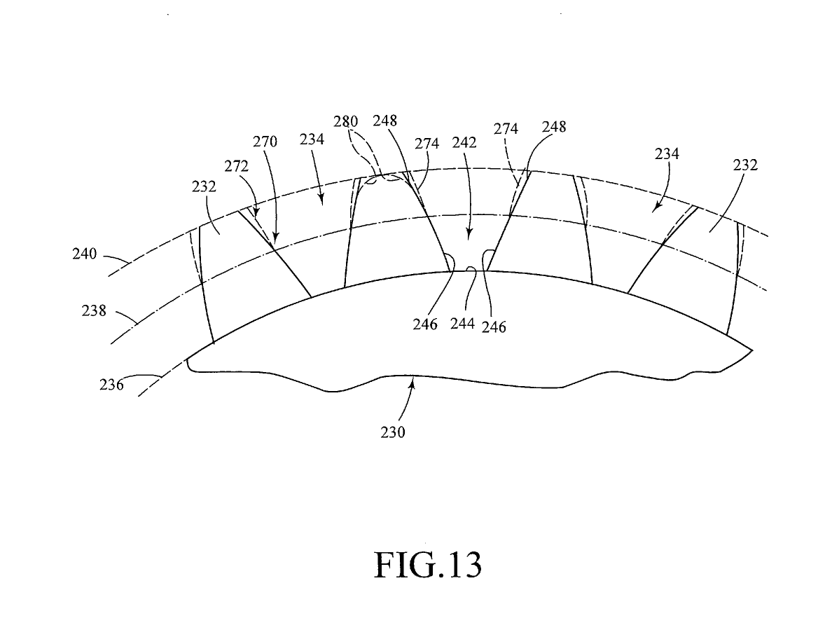

In an exemplary embodiment, the machine 100 may be programmed to machine a gear 230 out of the workpiece 202. In its final form, the gear 230 may be shaped as shown in FIG. 13. Accordingly, the gear 230 may have a series of gear teeth 232 separated by intervening gaps 234. Certain other dimensions may be used to define the shape of the gear 230, such as a root circle 236 forming the innermost boundary of the gaps 234, a base circle 238 which intersects the innermost point of contact between meshed gear teeth, and an outside circle 240 defining the outermost extent of each gear tooth 232. Each of the intervening gaps 234 may include a gap root portion 242. Each gap root portion 242 may be bounded by a bottom land 244 substantially coincident with the root circle 236 that extends between an adjacent pair of flank portions 246. The flank portions 246 extend outwardly from the root circle 236 to the base circle 238. Each gap root portion 242 may further be bounded by tooth faces 248 that extend from the base circle 238 to the outside circle 240 and generally define the surfaces that contact teeth from a counterpart, meshed gear. In the illustrated embodiment, the tooth faces 248 have an involute shape, however, other face shapes may be machined using the methods and apparatus disclosed herein.

To generate the intervening gaps 234 in the workpiece 202, the workpiece 202 may be secured in a workpiece retainer, such as the workpiece retainer 112. The workpiece 202 defines a work surface 260 to be engaged by tools of the machine 100. A rough cutting tool, such as the hob tool 206, may be provided in a rotatable rough tool retainer, such as the turret 108. The rough cutting tool may have a series of cutting teeth 212, each of which has a cutting tooth profile 216.

One or more of the workpiece retainer 112 and the turret 108 may be controlled such that the cutting teeth of the hob tool 206 engage the work surface of the workpiece 202, thereby to machine a series of initial gaps 270 in the workpiece 202, as shown in FIG. 11B. The hob tool 206 and workpiece 202 are rotated as they are brought into contact with each other. Each initial gap 270 may have an initial gap profile 272 that substantially conforms to the aggregate of the cutting tooth profiles 216. More specifically, each initial gap profile 272 may include the gap root portion 242 and an adjacent pair of initial tooth faces 274. The initial tooth faces 274 may not correspond to the final desired tooth face shape, and therefore may be removed as described in greater detail below.

Referring to FIG. 11A, a finish cutting tool, such as the milling tool 204, may have a finish cutting surface such as the cutting surfaces 224 of the cutting tool inserts 222. The milling tool 204 may be provided in a rotatable finish tool retainer, such as the spindle 106. One or more of the workpiece retainer 112 and the spindle 106 may be controlled such that the cutting surfaces 224 of the cutting tool inserts 222 travel along a series of tool paths. The milling tool 204 and the workpiece 202 may be rotated as the cutting tool insert travels along the tool paths. Each tool path may be configured to engage an associated initial tooth face 274 to machine a final tooth face 248. For example, the tool paths may have an involute shape to machine involute tooth faces 248. Accordingly, as noted above, each intervening gap 234 may include a gap root portion 242 that was machined by the hob tool 206 and an adjacent pair of final tooth faces 248 that were machined by the milling tool 204.

In some embodiments, the rough cutting and finish cutting steps may be performed sequentially. For example, a rough cutting operation may be performed, such as by engaging the hob tool 206 with the workpiece 202 as shown in FIG. 11B to form initial gaps 270. Subsequently, a separate finish cutting operation may be performed, such as by engaging the milling tool 204 with the workpiece 202 as shown in FIG. 11A to form the final intervening gaps 234.

Gear machining using sequential steps may use separate tool retainers as shown in FIGS. 11A and 11B, or alternatively may use a common tool retainer as both the rough tool retainer and the finish tool retainer. When a common tool retainer is used, a tool retainer adjustment step may be performed to change the common tool retainer from a roughing mode, in which the rough cutting tool is presented to the workpiece 202, to a finish mode, in which the finish cutting tool 202 is presented to the workpiece. If the common tool retainer is the turret 108, for example, the adjustment step may be performed by simply rotating the turret 108 so that the desired tool is presented to the workpiece 202. Alternatively, if the common tool retainer is the spindle 106, the tool changing device 143 may be used to detach the rough cutting tool and attach the finish cutting tool, or vice versa.

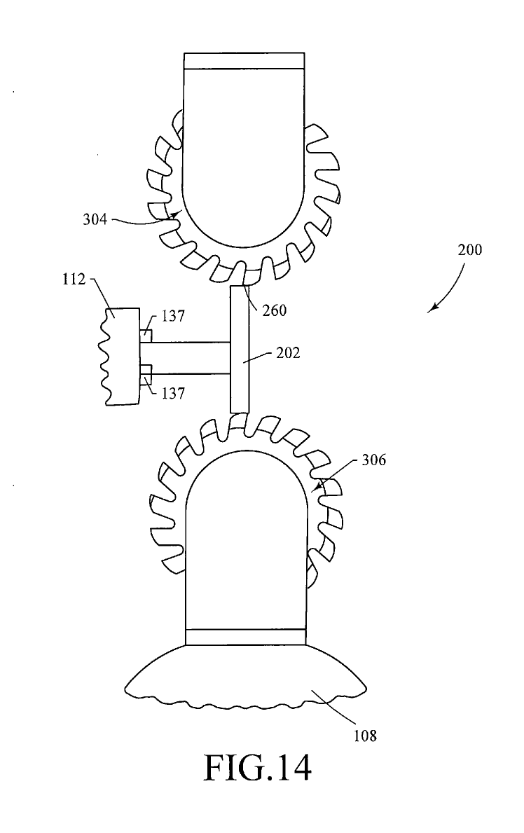

In an alternative embodiment illustrated at FIG. 14, the rough cutting and finish cutting steps may be performed simultaneously. In this embodiment, the machining area 200 may be configured with a finish cutting tool in the form of a finish hob tool 304 and a rough cutting tool in the form of a rough hob tool 306. As shown, the workpiece 202 may be movably supported by one of the workpiece retainers 112, and more particularly, secured between a plurality of jaws 137 thereof. The finish hob tool 304 may be similarly supported and secured by the tool retainer 106 of the spindle 144, while the rough hob tool 206, may be supported and secured by the turret 108. Moreover, one or more of the workpiece retainer 112, the tool retainer 106, and the turret 108 may be positioned such that cutting surfaces of the finish hob tool 304 and the rough hob tool 306 are readily capable of engaging even and adequate contact with the work surface of the workpiece 202 as shown. When the machining area 200 is configured in this manner, both rough cutting and finish cutting tools may engage the workpiece 202 simultaneously.

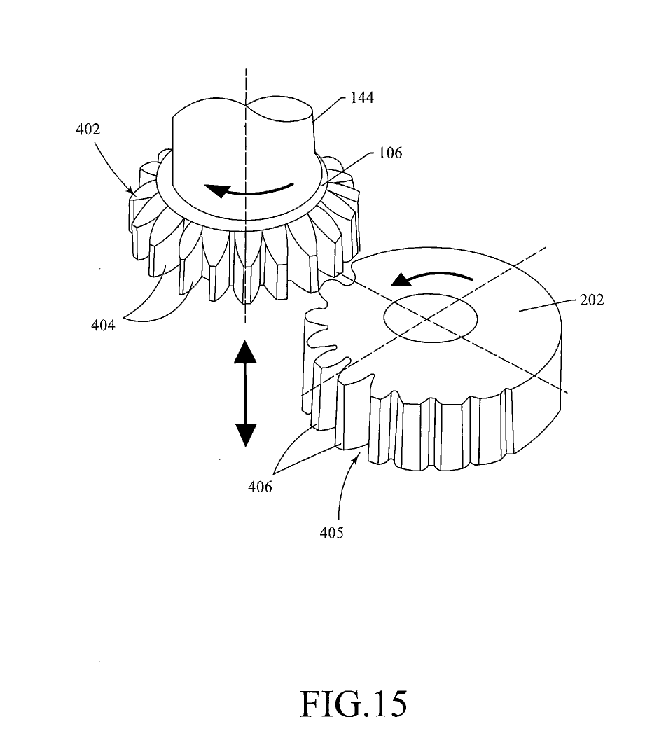

In some embodiments, the gear machining apparatus and method may incorporate gear shaping, as illustrated in FIG. 15. In gear shaping, a gear shaper 402 may be supported by a tool retainer, such as the tool retainer 106 of the spindle 144. The gear shaper 402 may be provided with gear cutting teeth 404. The workpiece 202 may be movably supported by one of the workpiece retainers. At least one of the gear shaper 402 and the workpiece 202 may be moved to cause a linear movement therebetween, so that the gear cutting teeth 404 engage the workpiece 202 to from gaps 405 between gear teeth 406 in the workpiece 202. The gear shaping process may be used as the rough cutting process, in which case the gaps 405 may have initial gap profiles including a gap root portion and adjacent initial tooth faces. Alternatively, the gear shaping process may be used as the finish cutting process, in which case the gaps 405 are final intervening gaps having final tooth faces. Still further, the gear shaping process may be combined with any of the milling cutter, hobbing, or other machining steps disclosed herein.

The gear machining method and apparatus may further be configured to machine one or more gear tooth profile modifications. In some applications, for example, the shape of the tip of the gear tooth may be reduced to provide for clearance or other considerations. These so-called tip relief surfaces 280 are shown in FIG. 13. Accordingly, one or more of the workpiece retainer and the finish tool retainer may be further controlled such that the finish cutting surface travels a series of tip relief tool paths proximate an outside circle of the gear, wherein each tip relief tool path engages a portion of an associated final tooth face 248 to machine a tip relief surface 280.

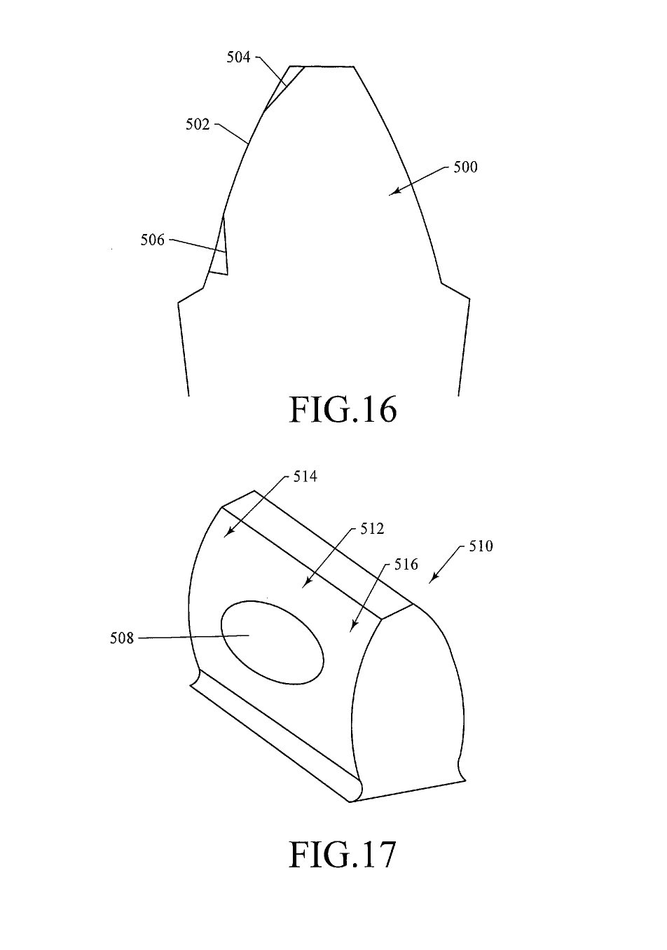

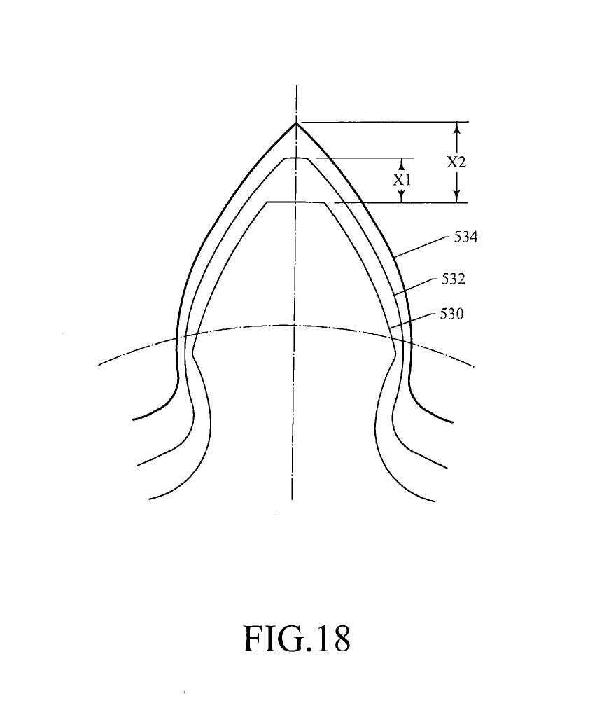

Additional gear tooth profile modifications are illustrated in FIGS. 16-18. At FIG. 16, a gear tooth 500 is shown having a face 502 modified with an alternative embodiment of a tip relief surface 504 formed near a top of the tooth 500. FIG. 16 also illustrates a root relief surface 506, in which a lower portion of the tooth 500 is removed. FIG. 17 illustrates a gear tooth 510 having a profile modification known as crowning. The crowned gear tooth 510 has surfaces that are modified in the lengthwise direction such that a center portion 512 of the tooth 510 bows farther outwardly than edge portions 514, 516 of the tooth. As a result, the crowned gear tooth 510 has a localized contact area 518 that engages the teeth of a meshed gear, which may be advantageous for high load applications. FIG. 18 illustrates embodiments of a tooth profile modification known as profile shift. A first tooth profile 530 shown in FIG. 18 has a substantially standard tooth profile. A second tooth profile 532 has a profile that has been shifted radially outwardly by a first distance X1. A third tooth profile 534 has a profile that has been shifted radially outwardly by a larger distance X2. While not shown in FIG. 18, the profile shift alternatively may be inwardly, toward the base circle. Profile shift modifications can make spur gears or helical gears run more quietly and carry more load.

For each of the profile modifications noted above, one or more of the workpiece retainer and the finish tool retainer may be further controlled such that the finish cutting surface travels a series of profile modification tool paths, wherein each profile modification tool path engages a portion of an associated final tooth face 248 to machine a profile modification surface.

Some of the gear machining apparatus and methods disclosed herein combine the efficiency of a tooth generation process with the flexibility of a tool path process. In other embodiments disclosed herein, a rough generation process and a finish generation process are combined. Accordingly, a wider variety of gear tooth profiles may be quickly machined using the fewer rough and finish cutting tools. This versatility also reduces the number of gear machining tools that must be kept on hand. Still further, a greater degree of customized gear tooth profiles may be machined, some of which may have non-standard shapes.

Although the embodiments disclosed herein may pertain to externally cylindrical surface geometries, the present disclosure may similarly be applied to other surface geometries, such as linear surface geometries, internally cylindrical surface geometries, and the like, without departing from the scope of the appended claims.

As supplied, the apparatus may or may not be provided with a tool or workpiece. An apparatus that is configured to receive a tool and workpiece is deemed to fall within the purview of the claims recited herein. Additionally, an apparatus that has been provided with both a tool and workpiece is deemed to fall within the purview of the appended claims. Except as may be otherwise claimed, the claims are not deemed to be limited to any tool depicted herein.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

What is claimed is:

1. A method of machining a gear from a workpiece, the gear having a series of gear teeth separated by intervening gaps, the method comprising:
securing the workpiece in a workpiece retainer, the workpiece having a work surface;
providing a rough cutting tool in a rough tool retainer, the rough cutting tool including a series of cutting teeth;
controlling one or more of the workpiece retainer and the rough tool retainer such that the cutting teeth engage the work surface to machine a series of initial gaps in the workpiece, each initial gap having an initial gap profile defined by the cutting teeth and including a gap root portion and an adjacent pair of initial tooth faces;
providing a finish cutting tool having a finish cutting surface in a finish tool retainer; and
controlling one or more of the workpiece retainer and the finish tool retainer such that the finish cutting surface machines each initial tooth face into a final tooth face, so that each intervening gap comprises a gap root portion disposed between an adjacent pair of final tooth faces.

2. The method of claim 1, in which the rough cutting tool comprises a rough hob tool and in which each initial gap profile is defined by the cutting teeth profile.

3. The method of claim 2, in which the finish cutting tool comprises one of a finish hob tool, a milling tool, and a gear shaper.

4. The method of claim 2, in which the rough hob tool comprises a hub, and in which the series of cutting teeth are configured to complete at least one helix around the hub.

5. The method of claim 2, in which the finish tool comprises a milling tool, in which one or more of the workpiece retainer and the finish tool retainer are controlled such that the finish cutting surface travels a series of finish tool paths, wherein each finish tool path comprises an involute shaped finish tool path, and in which each final tooth face has an involute shape.

6. The method of claim 1, in which controlling one or more of the workpiece retainer and the rough tool retainer to machine the initial gaps is performed simultaneously with controlling one or more of the workpiece retainer and the finish tool retainer to machine the final tooth faces.

7. The method of claim 1, in which one or more of the workpiece retainer and the finish tool retainer is further controlled such that the finish cutting surface travels a series of profile modification tool paths, wherein each profile modification tool path engages a portion of an associated final tooth face to machine a profile modification surface.

8. The method of claim 7, in which the profile modification surface comprises one modified surface selected from a group of modified surfaces consisting of a tip relief surface, a root relief surface, a crowned tooth surface, and a profile shift surface.

9. An apparatus for machining a gear from a workpiece, the gear having a series of gear teeth separated by intervening gaps, the apparatus comprising:
a workpiece retainer configured to movably support the workpiece, the workpiece having a work surface;
a rough tool retainer configured to be movable relative to the workpiece retainer;
a rough cutting tool coupled to the rough tool retainer, the rough cutting tool including a series of cutting teeth;
a finish tool retainer configured to be movable relative to the workpiece retainer;
a finish cutting tool coupled to the finish tool retainer; and
a computer control system including a computer readable medium having computer executable code disposed thereon and being in operative communication with each of the workpiece retainer, the rough tool retainer, and the finish tool retainer, the executable code configuring the control system to:
control one or more of the workpiece retainer and the rough tool retainer such that the cutting teeth engage the work surface to machine a series of initial gaps in the workpiece, each initial gap having an initial gap profile defined by the cutting teeth and including a gap root portion and an adjacent pair of initial tooth faces; and
control one or more of the workpiece retainer and the finish tool retainer such that the finish cutting surface machines each initial tooth face into a final tooth face, so that each intervening gap comprises a gap root portion disposed between an adjacent pair of final tooth faces.

10. The apparatus of claim 9, in which the rough cutting tool comprises a rough hob tool and in which each initial gap profile is defined by the cutting teeth profile.

11. The apparatus of claim 10, in which the finish cutting tool comprises one of a finish hob tool, a milling tool, and a gear shaper.

12. The apparatus of claim 10, in which the rough hob tool comprises a hub, and in which the series of cutting teeth are configured to complete at least one helix around the hub.

13. The apparatus of claim 10, in which the finish tool comprises a milling tool, in which the executable code configuring the control system further controls one or more of the workpiece retainer and the finish tool retainer such that the finish cutting surface travels a series of finish tool paths, wherein each finish tool path comprises an involute shaped finish tool path, and in which each final tooth face has an involute shape.

14. The apparatus of claim 9, in which the executable code configuring the control system further comprises controlling one or more of the workpiece retainer and the rough tool retainer to machine the initial gaps simultaneously with controlling one or more of the workpiece retainer and the finish tool retainer to machine the final tooth faces.

15. The apparatus of claim 9, in which the executable code configuring the control system further controls one or more of the workpiece retainer and the finish tool retainer such that the finish cutting surface travels a series of profile modification tool paths, wherein each profile modification tool path engages a portion of an associated final tooth face to machine a profile modification surface.

16. The apparatus of claim 15, in which the profile modification surface comprises one modified surface selected from a group of modified surfaces consisting of a tip relief surface, a root relief surface, a crowned tooth surface, and a profile shift surface.
